(19) United States
(12) Patent Application Publication
(10) Pub. No.: US 2021/0205922 A1
(43) Pub. Date: Jul. 8, 2021

(54) DUST MANAGEMENT METHOD AND SYSTEM FOR LASER MACHINING

(71) Applicant: LASER ENGINEERING APPLICATIONS, Angleur (BE)

(72) Inventors: Jose Antonio Ramos De Campos, Angleur (BE); Audrey Champion, Boncelles (BE); Laurent Lirot, Liège (BE); David Bruneel, Sougné-Remouchamps (BE); Axel Kupisiewicz, Neupré (BE)

(73) Assignee: LASER ENGINEERING APPLICATIONS, Angleur (BE)

(21) Appl. No.: 17/059,073

(22) PCT Filed: Jun. 7, 2019
(86) PCT No.: PCT/EP2019/064920

§ 371 Date: Nov. 25, 2020

(30) Foreign Application Priority Data
Jun. 8, 2018 (BE) BE2018/5382

(51) Int. Cl. B23K 26/142; B23K 26/70

(52) U.S. Cl. CPC B23K 26/142; B23K 26/0648; B23K 26/703

(57) ABSTRACT

A laser machining device includes a generator and a director to generate and to direct, respectively, a gas stream to an area lying above a machining support in such a way as to create a suction effect that entrains machining dust away from said machining support.

### TECHNICAL FIELD

The present invention relates to a method and a system for managing dust for laser machining.

### BACKGROUND

The term “machining a workpiece” usually refers to the application of one or more material removal techniques to give a desired function, roughness, geometry, shape and/or dimensions to the part. Such techniques are widely used today because they allow us to obtain very high precision workpieces.

The machining of a workpiece can be achieved by focusing a laser ray to generate a large amount of energy on a small portion of the workpiece. This technique is called “laser machining” (or “laser ablation”). The more specific term “laser micromachining” is used to refer to laser machining when the tolerances or dimensions associated with the workpiece are in the micrometer range.

During a machining of a workpiece, whether or not it is done with a laser, dust is generally produced. These include, among other things, debris, chips, filings, or other splashes. These dusts are not intended to be incorporated into the workpiece. They should therefore be removed and/or collected and/or recycled.

The document JP H11 254176 A discloses an equipment for collecting combustion dust generated during the machining of a paper band, such as cigarette filter paper, for making openings in it. This equipment comprises conducts to both convey and recover an air stream over the band.

This equipment is sufficient to recover combustion dust from the machining of the band. However, it is not sufficient to evacuate and recover machining dust during the production of certain polymer-based medical devices, but also when removing certain coatings with a laser. Indeed, during laser machining of such a workpiece, the focusing of a laser ray on a portion of a workpiece is likely to generate a rise in the temperature of the material constituting this portion. The dust produced is then likely to contaminate the machined workpiece because it can remain stuck to its surface due to the viscosity and high temperature of the material. Fast and efficient dust removal and management during laser machining is therefore a critical issue. In particular, to date, the use of current laser machining technologies to produce certain high-precision workpiece is made impossible when the risk of dust contamination is too great.

### SUMMARY OF THE INVENTION

An object of the present invention is to provide a method for managing dust that appears during laser machining (or laser micromachining), the implementation of which is simple, allowing particularly rapid and efficient evacuation of said dust away from the workpiece.

For this purpose, the invention provides a method for managing machining dust during laser machining of a workpiece, the method comprising the following steps:

(i) providing a laser machining device comprising:
a laser source;
a machining support comprising a top end and a bottom end;
   for receiving and supporting a workpiece
      by the application of a force directed from the bottom end toward the top end;
an optical system
   for directing a laser beam generated by the laser source toward the machining support,
      according to one or more attack trajectories,
         each of the one or more attack trajectories being characterized by a vector [symbol] directed at least partially from the top end toward the bottom end;
generating means for generating a gas stream;
directing means
   for directing the gas stream toward a zone lying above the machining support, along a main trajectory characterized, above the machining support, by a vector \vec{v} directed partially from the bottom end toward the top end;
      to create a suction effect able to entrain a gas away from the machining support;
recovery means for recovering at least part of the gas;

(ii) placing the workpiece on the machining support;

(iii) activating the laser source for generating the laser beam;

(iv) direct the laser beam
by means of the optical system
toward the machining support,
   according to the one or more attack trajectories;

(v) activating the generating means to generate the gas stream;

(vi) directing the gas stream
by means of the directing means,
toward the zone lying above the machining support,
   along the main trajectory, above the workpiece,
      to create the suction effect,
         to entrain the gas away from the machining support;

(vii) recovering at least part of the gas
by means of the recovery means.

The method proposed by the invention is particularly advantageous. It is very simple to implement and allows a very fast and efficient evacuation of dust likely to appear during laser machining (or laser micromachining) of the workpiece carried out by means of the laser beam.

Before supporting this assertion, it should be recalled that the geometry of the ambient spatial space in which problems of physics and basic classical mechanics are considered at our scale is usually that of a three-dimensional Euclidean space without curvature, i.e. a vector space provided with a scalar product, which is preferably provided with an Cartesian coordinate system (with perpendicular axes and the same unit of length for the axes), and which can be assimilated to the vector space

[symbol]

³={(x,y,z):x,y,z∈ [symbol] }.

We will adopt this space algebraic-geometric model for the purposes of this document. We will refer to it, among other things, as “space” or “three-dimensional Euclidean space”, these terms that are generally understood for the purposes of this document.

In addition, for the purposes of this paper, the term “vector” refers to a vector of the space, i.e. an element of the vector space [symbol] ³. It should be recalled that a space vector can be seen as a geometrical representation of a displacement in the space. In particular, a vector is completely characterized by its magnitude, direction and orientation.

It is known to a person skilled in the art that a scalar product called Euclidean and canonical is defined on the vector space [symbol] ³ by the definite-positive symmetric bilinear application

[symbol]

−|− [symbol] : [symbol] ³× [symbol] ³→

[symbol]

defined by

[symbol]

(x,y,z)|(x′,y′,z′) [symbol] :=xx′+yy′+zz′

for all vectors

(x,y,z),(x′,y′,z′)∈ [symbol] ³

This canonical Euclidean scalar product is also commonly and more simply referred to as “the scalar product”. We will adopt this terminology in the following summary of the invention.

It should be recalled that a vector [symbol] is said to be partially directed from a point A to a point B if [symbol] | [symbol] [symbol] ≥0. This essentially means that the vector [symbol] is the same orientation as the orthogonal projection of the vector [symbol] on the vector [symbol] .

It should be also recalled that the Euclidean space [symbol] ³ is provided with a notion of distance d associated to the scalar product and defined by

d((x,y,z),(x′,y′,z′)):=\sqrt{(x′−x)²+(y′−y)²+(z′−z)²}

for any points (x,y,z) and (x′,y′,z′) of the space. This notion of distance corresponds to the notion of intuitive distance that the man in the street uses daily to carry out measurements at our scale.

Moreover, it is well known to a person skilled in the art that the scalar product of two vectors in the vector space [symbol] ³ is intimately associated with a measurement of the geometrical angle between these vectors. More precisely and more specifically, if P and Q are two points in the space [symbol] ³, and if O designates the origin for a certain Cartesian coordinate system of the space, the internal angle of the triangle POQ at the vertex O, commonly noted [symbol] , can be implicitly obtained by the formula

[symbol]

| [symbol] =d(O,P)d(O,Q)cos( [symbol] )

where cos ( [symbol] ) designates the cosine of the angle [symbol] . It should be recalled, moreover, that two space vectors are orthogonal if and only if their scalar product is null. In order to remove any ambiguity, it should be specified that the scalar product of two space vectors is negative (respectively, positive) if and only if it is strictly negative (respectively, strictly positive) or null.

This mathematical framework being detailed, we specify what we mean by the terms “attack trajectory” and “main trajectory” in the statement of the method according to the invention. These precisions are considered optional for a person skilled in the art who is accustomed to the application of laser machining methods. An “attack trajectory” of a laser beam directed toward one or more points in the space (or, more precisely, to the machining support) is the trajectory defined by the laser beam as it arrives at the one or more points. In particular, it is not a global trajectory that would be defined by the entire laser beam, from the laser source, to said one or more points in the space. A “main trajectory” of a moving gas stream in space is defined by an average of the trajectories of each of the gas particles of the gas stream in the space. When these one or more attack trajectories and main trajectories are essentially defined by a straight line or line segment, they can be characterized by a vector parallel to the line or line segment, the orientation of which determines an orientation of travel of the trajectory.

In the following paragraphs, we show how the method proposed by the invention allows the removal of dust appearing during laser machining (or laser micromachining) of the workpiece carried out by means of the laser beam. In the following, we will not go into detail regarding the advantages and preferred options relating to the laser source, the optical system or the machining support, as these elements are considered to be known and mastered by a person skilled in the art accustomed to putting laser machining methods into practice.

When the laser source is activated, a laser beam is generated according to the techniques known by a person skilled in the art. The optical system makes it possible to direct this laser beam toward the machining support of the laser machining device, and thus at least partially toward the workpiece when the latter is positioned on the machining support of the device, the direction of the laser beam being made according to one or more attack trajectories characterized by a vector [symbol] of the space.

The workpiece is supported by the machining support by the application of a reaction force [symbol] directed from the lower end of the machining support to the top end of the machining support. Essentially, the workpiece is in contact with the top end of the machining support. The vector [symbol] is directed at least partially from the top end of the machining support to the bottom end of the machining support. The orthogonal projection of the vector [symbol] onto the vector [symbol] and the vector [symbol] are therefore in opposite orientations.

When the generating and directing means of the laser machining device according to the invention are activated, a gas stream is generated and directed toward a zone of the space lying above the machining support, along a main direction characterized, preferably at least above the machining support, by the vector i; directed partially (or, equivalently, partially parallel) from the bottom end to the top end. In particular, this gas stream is directed toward a part of the space that comprises and/or at least partially lies above the workpiece. The gas stream then follows, on average, a trajectory according to the direction of the space defined by a straight line parallel to said vector, toward the target zone. The overall trajectory of the gas stream may subsequently vary (e.g. due to gravity), the main point being that the initial direction of the gas stream in the zone lying above the machining support, and preferably between the directing means and the zone lying above the machining support, is approximately along a straight line, according to an orientation defined by the vector \vec{v}, and toward the zone.

This zone constitutes a part of the space that comprises an open set relative to the Euclidean norm associated with the scalar product, this open set comprising and/or at least partially lying above the workpiece. As a result, the gas stream is passive above, close to the machining support and the workpiece.

The vector \vec{v} is directed partially from the bottom end of the machining support to the top end of the machining support. We insist on the fact that this information concerns the vector and not the main trajectory. In particular, the directing means are thus necessarily configured so that it is possible to translate the main trajectory of the gas stream so that it attacks the machining support from its bottom end. However, the main trajectory of the gas stream is not necessarily configured to attack the machining support.

Since the vector [symbol] is directed partially from the bottom end of the machining support to the top end of the machining support, the orthogonal projection of the vector [symbol] on the vector [symbol] and the vector [symbol] are in the same orientation. As a result, the component of the vector [symbol] according to an axis of an orthogonal coordinate system that would be defined by the vector [symbol] has the opposite sign to the component of the vector [symbol] according to the same axis. Otherwise explained, the orientation of propagation of the gas stream according to an axis defined by the reaction force of the machining support is opposite to the orientation of the vector characterizing the one or more attack trajectories of the laser beam.

Concretely, in the case where the space is provided with the canonical Cartesian coordinate system defined by the vectors
(1,0,0), (0,1,0) et (0,0,1)

corresponding respectively to three axes of the coordinate system, if we have [symbol] =(0,0,1)=− [symbol] , the one or more attack trajectories of the laser beam are directed “from the top to the bottom”, while the gas stream is directed “from the bottom to the top”, in a direction essentially transverse to the coordinate system.

The formalism used in the formulation of the method generalizes these considerations. Thus, taking into account the fact that the gas stream passes close to the workpiece as discussed above, an optimal evacuation of the dust that appears during laser machining of the workpiece is guaranteed far away from this latter. Indeed, the nature of the machining process means that these machining dusts remain close to the workpiece and/or are projected toward the zone. The blast of the gas stream passing close to the workpiece in the zone, thus directed, generates a suction effect that can draw a gas containing these dusts away from the workpiece. This gas typically consists of ambient air mixed with machining dust. These machining dusts are then entrained by the gas stream and discharged away from the immediate vicinity of the workpiece due to the direction and orientation of propagation of the gas stream previously discussed and defined from a carefully chosen main direction. This results in a fast and particularly effective separation of dust on the surface and/or in the vicinity of the workpiece.

As the gas stream continues to travel beyond the zone, these machining dusts, as well as the gas as a whole, are sucked into the stream and mixed with it until the recovery means recover this gas, at least partially. Thus, in addition to the simple and effective evacuation of machining dust, the method according to the invention proposes a recovery of machining dust in order to greatly limit the risks of contamination of the workpiece.

The suction effect is typically created by a vacuum since it follows the creation of a gas stream directed into the zone lying above the machining support. Preferably the suction effect is created by the Venturi effect. In general, since the main trajectory is characterized above the machining support (and therefore above the workpiece) by the vector [symbol] , it follows that the suction effect according to the invention constitutes an aerodynamic suction effect directed (at least partially, preferably overall) according to the vector [symbol] and which is advantageously capable of sucking and/or extracting dust from the surface of the workpiece during machining. In particular, thanks to the component of the vector i associated with the “vertical” direction defined from the bottom end to the top end of the machining support, it is thus possible to suck up both the dust lying above the workpiece but also and especially such dust that would be at the level of the surface of this workpiece. This feature is important when machining high-precision workpieces such as intraocular lenses, polymers and/or microprocessors.

Advantageously, the implementation of this method is extremely simple and inexpensive. Indeed, considering the infrastructures necessary for laser machining as being provided in an obvious way considering the problem that concerns us, this implementation requires only the means for generating a single gas stream along a single direction transverse to the one or more attack trajectories of the laser beam. In particular, in addition to the laser source, the machining support and the optical system, the means for carrying out the method according to the invention are widely known to a person skilled in the art, very simple to design, inexpensive and space-saving. Thus, the claimed method takes full advantage of the benefits of available technological developments.

Advantageously, the method according to the invention now makes it possible to use laser machining technologies to clean and/or produce certain high-precision workpieces that it was not previously possible to clean and/or produce due to the excessive risk of dust contamination. In particular, and preferentially, the workpiece is intended to be incorporated or to form an integral part of a medical device or a medical implant made mainly of polymers. Preferably, the workpiece comprises an intraocular lens, a thin layer of material intended for the photovoltaic field and/or a proton component.

Preferentially, the workpiece is mechanically coupled to the machining support during the execution of the method in order to hold it in a fixed position. Preferably, the workpiece lies above the machining support.

Preferentially, the laser machining device further comprises a gas stream generator comprising the generating means and the directing means. More preferably, the generator is a hydraulic system capable of supplying the compressed air.

Preferentially, the gas stream is a clean air stream. More preferably, the clean air stream is a laminar air stream. Even more preferably, the air stream is a laminar air gap that allows the generation of an optimal suction effect in the zone lying above the machining support. Advantageously, such an air gap allows the generation of an optimal suction effect of the machining dust in the vicinity of the workpiece.

Preferentially, the gas stream consists of an air gap moving along a surface, a part of which is a portion of a plane parallel to the vector \vec{v}, when the generating means are in action; the main trajectory of the gas stream consisting of a curve on the surface; a distance between the surface and the machining support being smaller than thirty centimeters, preferably smaller than twenty centimeters, more preferably smaller than ten centimeters, even more preferably, being approximately one centimeter. This distance is preferentially defined as the smallest Euclidean distance between a point on the surface and a point on the machining support. An advantage of this preferred embodiment of the device is that it is particularly simple and compact. It allows dust to be removed by directing the gas stream close to the machining support according to a single main trajectory.

Preferably, the volume of the zone lying above the machining support is limited to 1 m³. Preferably, the zone lying above is a portion of an ellipsoid or rectangular parallelepiped. More preferentially, the zone lying above is a portion of open sphere of radius R>0. Even more preferentially, the radius R is smaller than 20 centimeters, even more preferentially, the radius R is smaller than 10 centimeters. Preferentially, the sphere portion is a half sphere that is centered in the center of gravity of the workpiece.

Preferentially, the smallest distance between an arbitrary point on the workpiece and a gas particle of the gas stream is comprised between 0.1 and 30 centimeters, more preferentially between 1 and 20 centimeters. Even more preferentially, this distance is about one centimeter.

Preferably, the one or more attack trajectories pass through the zone. Preferably, the one or more attack trajectories pass through the gas stream.

Preferentially, if A, B and C are three points in space such that the displacement represented by the vector [symbol] sends the point A to the point B and the displacement represented by the vector \vec{v} sends the point A to the point C, then the internal angle at the vertex of the triangle BAC is comprised between 98° and 170°, more preferentially, between 120° and 150°, even more preferentially, between 130° and 140°, even more preferentially, this angle is 135°.

Preferably, the gas entrained at a distance from the machining support comprises of ambient air and machining dust. More preferentially, the gas entrained at a distance from the machining support consists of ambient air and machining dust.

Preferably, the gas is entrained at a distance comprised between one and thirty centimeters from the machining support.

Preferentially, the recovery means recover more than 50% of the gas, more preferably, more than 75% of the gas, more preferably, more than 90% of the gas, even more preferably, more than 99% of the gas. Preferentially, the recovery means recover at least part of the gas stream, more preferably more than 90% of the gas stream, more preferably more than 99% of the gas stream.

Preferentially, the recovery means recover at least one, preferably at least three, even more preferably at least ten, even more preferably at least thirty, cubic millimetres of machining dust per minute, when the device according to the invention is in action. Preferably, the recovery means recover between fifteen and eighty micrograms of machining dust per minute, when the device according to the invention is in action. Preferably, the recovery means recovers at least a portion of the gas stream loaded with gas and machining dust.

Preferably, the recovery means are capable of treating and/or eliminating the machining dust that is present in the gas.

Preferably, the method according to the invention is carried out automatically by means of a logic unit.

The method according to an embodiment further comprises the step of:

(viii) cooling at least one of:
the machining support,
the workpiece,
the gas.

This embodiment of the method according to the invention is particularly advantageous. Indeed, during the application of the method, the focusing of the laser beam on a portion of a workpiece usually generates a rise in the temperature of the material constituting this portion. The cooling of at least one of the machining support, the workpiece and the gas helps to prevent possible contamination of the workpiece by machining dust sticking to its surface due to the viscosity and high temperature of the material. This makes it easier for the machining dust to be entrained in the gas at a distance from the machining support because it does not stick to the workpiece. This embodiment therefore contributes to a faster and more efficient removal of the machining dust. In addition, irrespective of the addition of this cooling step, it should be noted that the suction effect generated by a vacuum as such always produces a cooling effect on the dust and/or the gas, so that even if dust were to fall back onto the workpiece, it would no longer stick thereto.

Preferably, the workpiece and/or the gas is cooled directly by the Venturi effect, and/or by means of a Peltier system mechanically coupled to the machining support, and/or by means of a cooling system.

According to a first embodiment of this embodiment of the method, the machining support is first cooled by means of a Peltier system mechanically coupled to the machining support and the workpiece is then cooled by conduction. According to a second embodiment of this embodiment of the method, the gas is cooled by the Venturi effect. According to a third embodiment of this embodiment of the method, the workpiece is cooled directly by Venturi effect and/or by means of a Peltier system mechanically coupled to the machining support.

According to an embodiment, a distance, measured along a vertical direction directed from the bottom end toward the top end, separating a center of the gas stream, preferably the main trajectory, and the workpiece is between 0.1 and 20 centimeters, preferably between 0.1 and 10 centimeters, preferably between 0.5 and 5 centimeters. According to the preferred embodiments of the invention:
the gas stream generated in step (v) consists of an air gap with a width of between 10 and 30 centimeters;
the gas stream is generated in step (v) and directed in step (vi) with a stream of velocity of between 0.2 and 10 meters per second, preferably between 0.5 and 5 meters per second, more preferably between 1 and 2 meters per second;
the gas stream generated in step (v) with a stream flow rate comprised between 20 and 100 cubic meters per second, preferably between 45 and 55 cubic meters per second;
the gas stream generated in step (v) consists of an air gap having, at the exit of the directing means, an area corresponding to a value between 10 and 20 centimetres multiplied by a value between 0.5 and 5 centimetres, preferably an area of 45 square centimetres;
even more preferably this air gap has, at the exit of the directing means, a rectangular cross-section, the sides of the rectangles having lengths of between 10 and 20 centimetres and between 0.5 and 5 centimetres respectively, preferably 15 and 3 centimetres respectively.

A selection and/or all of these previous preferred embodiments can be combined with each other or not. These numerical data make it possible to amplify the technical effect of gas suction at a distance from the machining support.

Another object of the present invention consists in providing a laser machining device (or laser micromachining) whose implementation is very simple and which allows a very fast and efficient management and/or evacuation of machining dust away from the workpiece.

For this purpose, the invention provides a laser machining device comprising:
a laser source;
a machining support comprising an top end and a bottom end
   for receiving and supporting a workpiece
      by the application of a force directed from the bottom end to the top end;
an optical system
   for directing a laser beam generated by the laser source toward the machining support,
   according to one or more attack trajectories,
      each of the one or more attack trajectories being characterized by a vector \vec{AB} directed at least partially from the top end toward the bottom end;
generating means for generating a gas stream;
directing means
   for directing the gas stream toward a zone lying above the machining support,
      along a main trajectory characterized, above the machining support, by a vector \vec{v} directed partially from the bottom end to the top end;
         to create a suction effect able to entrain a gas away from the machining support;
recovery means for recovering at least part of the gas.

The mathematical and terminological framework used in the presentation of the method according to the invention extends mutatis mutandis to the aforementioned presentation of the device according to the invention. The embodiments and the advantages of the method according to the invention are transposed mutatis mutandis to the present laser machining device.

In particular, the machining device according to the invention is particularly advantageous. It is very simple to operate and allows a very fast and efficient removal of dust that may arise during laser machining (or laser micromachining) of the workpiece carried out by means of a laser beam.

Some particular embodiments of the device according to the invention will now be detailed. These can be directly transposed into, or correspond to, particular embodiments of the method according to the invention.

According to an embodiment of the device, the one or more attack trajectories pass through the gas stream when the generating means are in action.

Advantageously, when the machining device according to this embodiment of the invention is in action, considering the machining dust which is projected in the zone lying above the machining support after an impact of the laser beam on a workpiece arranged on the machining support, these dusts are projected toward a region of space upstream of one or more laser beam attack trajectories, and therefore, they are projected toward a region of the space defined by the intersection between the trajectory of the gas stream and the zone, so as to transversely meet the gas stream, and to be all the more easily entrained by it when they are comprised in the gas.

The efficiency of the machining device is all the more increased when the one or more attack trajectories meet the trajectory of the gas stream.

In particular, the trajectories defined by the vectors [symbol] and [symbol] are preferably secant.

According to an embodiment of the device, the gas stream is a laminar air stream.

Advantageously, such a gas stream is simple and inexpensive to produce. Moreover, the trajectory of such a gas stream is advantageously straighter and easier to control.

Preferably, the gas stream is a clean and/or dry laminar air gap. Advantageously, the suction effect generated by such a gas stream is amplified.

According to the embodiment of the device, the gas contains machining dust.

Preferably, the gas comprises the ambient air and machining dust. Preferably, the gas consists of machining dust and the ambient air. Preferably, the gas comprises at least 50% of the dust, more preferably at least 75% of the dust, more preferably at least 90% of the dust, more preferably at least 99% of the dust.

According to an embodiment of the invention, the device further comprises channelling means for channelling the gas stream between the directing means and the recovery means.

Advantageously, the channelling means allow the trajectory of the gas stream to be better controlled. The initial direction of the gas stream in the zone lying above the machining support also corresponds more closely to that of the vector [symbol] , since it is guided by the channelling means and protects it from the influence of external factors.

Advantageously, such channelling means are widely known to a person skilled in the art, very simple to design, inexpensive and space-saving.

According to an embodiment of the invention, the device further comprises channelling means which satisfy the following properties:
they are configured to channel the gas stream between the directing means and the recovery means,
they comprise at least one opening for receiving the gas entrained by the suction effect,
they are configured to channel the gas between the at least one opening and the recovery means.

Advantageously, the channelling means allow the trajectory of the gas stream and the gas to be better controlled from their entry into the channelling means to the recovery means. The initial direction of the gas stream in the zone lying above the machining support also corresponds more closely to that of the vector \vec{v}, as it is guided by the channelling means and protects it from the influence of external factors. The opening makes it possible to channel the gas suction into the channelling means and advantageously controls the removal of a large number of machining dusts contained in the gas away from the workpiece.

Advantageously, such channelling means are widely known to a person skilled in the art, very simple to design, inexpensive and space-saving.

Preferably, the channelling means comprise a conduct of essentially constant cross-section with a protuberance on its inside.

According to any one of the embodiments of the device comprising the channelling means, the latter comprise a conduct having a first and a second ends, the conduct also having a cross-section of variable area which has, in an intermediate portion located between the first and second ends, an area smaller than the area of the cross-section at the first and second ends.

Preferably, the zone at least partially comprises the intermediate portion. Preferably, the opening is located at least partially in the intermediate portion.

Preferably, according to the embodiment of the device previously explained, the suction effect is generated by a depression of the gas stream in the conduct.

This embodiment occurs, in particular, when a decrease in the cross-sectional area of the conduct on the trajectory of the gas stream causes an increase in the speed of the gas stream in the conduct, and thus a decrease in the pressure. This phenomenon is called the Venturi effect. More preferentially, the suction effect is therefore generated by a Venturi effect in the conduct.

Advantageously, the embodiment of such a conduct are widely known to a person skilled in the art, very simple to design, inexpensive and space-saving.

Preferably, the conduct is a Venturi tube.

According to the embodiment of the device, the suction effect is capable of cooling the machining support and/or the gas.

Advantageously, this cooling helps to prevent possible contamination of the workpiece with machining dust that may adhere to the surface due to the high viscosity and temperature of the workpiece material.

Preferably, the gas consists of the ambient air and machining dust that can be cooled by the suction effect. Preferably, the suction effect is generated by a Venturi effect.

According to an embodiment of the invention, the device further comprises a cooling system for cooling the machining support and/or the gas.

This embodiment of the method according to the invention is particularly advantageous. Indeed, when the machining device is in action, the focusing of the laser beam on a portion of a workpiece usually generates an increase in the temperature of the material constituting this portion. The cooling of the machining support and/or the gas helps to prevent possible contamination of the workpiece by machining dust sticking to its surface due to the viscosity and high temperature of the material. This reduces the adhesion of the machining dust to the workpiece and makes it easier for the dust to be entrained away from the machining dust in the gas. This embodiment therefore contributes to a faster and more efficient removal of the machining dust.

Preferably, the cooling system is a Peltier system that is mechanically coupled to the machining support and is capable of cooling the workpiece by conduction when it is placed on the machining support.

Preferably, the machining device according to the invention comprises a logic unit configured, on the one hand, to coordinate the activation of the laser source, generating means and recovery means, and, on the other hand, to control the optical system and directing means so as to determine the direction of the laser beam and that of the gas stream.

### BRIEF DESCRIPTION OF THE FIGURES

Other characteristics and advantages of the invention will appear when reading the following detailed description, for the understanding of which one will refer to the annexed figures among which:

FIG. 1 illustrates a three-dimensional view of a laser machining device according to an embodiment of the invention;

FIG. 2 illustrates a transverse view of a laser machining device according to an embodiment of the invention.

The drawings of the figures are not to scale. Generally, similar elements are denoted by similar references in the figures. For the purposes of this document, identical or similar elements may bear the same references. In addition, the presence of reference numbers in the drawings cannot be considered limiting, even when these numbers are indicated in the claims.

### DETAILED DESCRIPTION OF PARTICULAR EMBODIMENTS OF THE INVENTION

The present invention is described with particular embodiments and references to figures but the invention is not limited by them. The drawings or figures described are only schematic and are not limiting. For the purpose of the present document, the notion of “mechanical coupling” between two elements preferably refers to a fixed mechanical holding of the positions of these two elements in relation to each other. In particular, a mechanical coupling between two elements includes the possibility of a direct fixation between these two elements, but also that of an indirect fixation by means of at least one intermediate element. However, a mechanical coupling between two elements does not formally exclude a possible relative movement between these two elements.

For the purposes of this document, the terms “machining”, “laser machining” and “laser micromachining” are defined in the “Background” section of this document. These definitions apply throughout this document. It should be remembered that laser machining of a workpiece is a technique for removing material from the workpiece by focusing a laser ray so as to generate a large amount of energy on a small portion of the workpiece. It should also be remembered that a micromachining (respectively, laser micromachining) is a particular type of machining (respectively, laser machining) when the tolerances or dimensions associated with the workpiece are of the order of a micrometer.

For the purposes of this document, “dust” generated during machining refers not only to dust but also to debris and/or chips and/or filings and/or splashes that are generated by the material of the machined workpiece and are not intended to be incorporated into the machined workpiece.

For the purposes of this document, the “inside” of a hollow three-dimensional object is the space enclosed within the concave surface defined by the object itself. In particular, the inner volume of the object is, by definition, finite, while the outside volume of the object is infinite.

For the purpose of this document, a “negative number” is a number smaller or equal to zero, and a “strictly negative number” is a non-zero negative number.

For the purpose of this document, the term “space” is used to refer to the three-dimensional ambient spatial space without curvature in which problems of classical physics and mechanics are usually considered at our scale. Typically, for the purposes of this document, we will assimilate this space to the vector space.

[symbol]

³={(x,y,z):x,y,z∈ [symbol] }.

with the canonical Cartesian coordinate system defined by the vectors
(1,0,0), (0,1,0) et (0,0,1)

corresponding respectively to three axes of the coordinate system noted and represented by the letters X, Y and Z in this document. This space is provided with a canonical Euclidean scalar product, generally called “scalar product” and precisely defined in the summary of the invention of this document.

For the purpose of this document, a “three-dimensional space direction” is defined by the data of a straight line of the space. In particular, two lines of the space define the same direction if and only if they are parallel.

For the purpose of this document, each line in the space has two path “orientations”. If A and B are any two separate points on a line in space, then the path of the line through A first and B second defines a first orientation, while the path of the line through B first and A second defines a second orientation, which is called the orientation “opposite” to the first orientation. These two orientations can be defined equivalently by the data of the vectors

[symbol]

and \vec{BA}=−

[symbol]

respectively.

It should be remembered that a space vector can be seen as a geometrical representation of a displacement in the space. In particular, a vector is completely characterized by its magnitude, direction and orientation. In the context of a graphical representation, and more particularly, in the context of the figures presented in this document, the location of a vector in the space or in relation to a spatial coordinate system is of no importance.

For the purpose of this paper, we will say that a vector “ [symbol] is directed from a point A to a point B” if there is a number r>0 such that [symbol] =r\vec{v}. For the purpose of this paper, we will say that a vector “ [symbol] is partially directed from a point A to a point B” if [symbol] | [symbol] ≥0. Equivalently, this inequation indicates that the component of the vector [symbol] along an axis defined by the vector [symbol] is positive, i.e. that these vectors have the same orientation along this axis.

For the purpose of this paper, a “trajectory” of a point in the moving space is a curve described by the movement of that point in the space. A “trajectory is said to be characterized by a vector of the space” when the trajectory can be defined by means of a straight line or a segment of a straight line running parallel to said vector, in the orientation of said vector.

For the purpose of this document, an “attack trajectory” of a laser beam directed toward one or more points in the space is the trajectory defined by the laser beam as it arrives at the one or more points in space. In particular, it is not the overall trajectory defined by the assembly of the laser beam from the laser source to one or more points in the space.

For the purpose of this document, a “main trajectory” of an assembly of particles (for example, belonging to a fluid or a gas) moving in the space is defined by an average of the trajectories of each of the particles in the space.

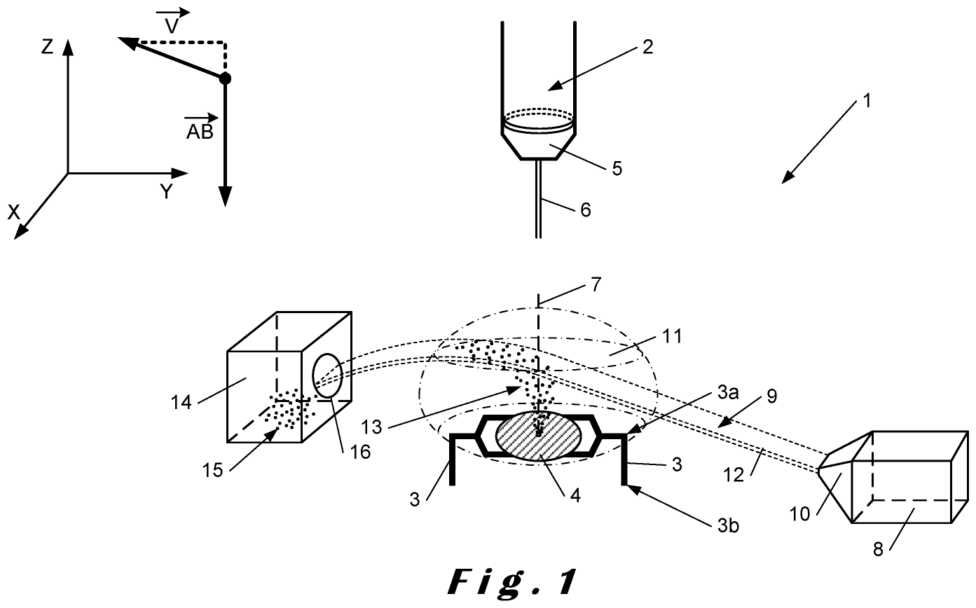

FIG. 1 illustrates a laser machining device 1 according to an embodiment of the invention.

This illustration is realized in the three-dimensional ambient space, assimilated to [symbol] ³ and provided with the Cartesian coordinate system represented by the axes X, Y and Z. It should be remembered that the position of the coordinate system and the vectors in this illustration is in no way limiting the scope of the claimed invention. The coordinate system and the vectors of the space represented in this illustration could have been positioned anywhere in the space in a scientifically and technically equivalent manner.

The laser machining device 1 comprises a laser source 2, a machining support 3 and an optical system directing a laser beam 6 generated by the laser source 2 to the machining support 3. The assembly of these elements of the device 1 constitute an obvious and elementary basis for a laser machining device whose technical and functional characteristics are mastered by a person skilled in the art.

The objective of the device 1 is to machine a workpiece 4 placed on the machining support 3. The workpiece 4 can be mechanically coupled to the machining support 3 for more stability. Although not clearly shown in the illustration, the workpiece 4 is preferably a medical implant made of high-precision polymers for which the risk of contamination by machining dust is very high and for which the importance of evacuation and management of this dust is crucial. This preferred embodiment of the workpiece 4 is not limiting the scope of the invention. In particular, a workpiece comprising at least one of a thin layer of material for use in the photovoltaic field or a protonic component would not depart from the scope of the invention.

The laser beam is directed along an attack trajectory 7 characterized by a vector [symbol] . The attack trajectory 7 is represented in a non-oriented manner by a line segment in lines. In the case of this representation, the vector [symbol] is of the form (0,0,−z) for a certain number z>0.

The machining support 3 comprises a top end 3a and a bottom end 3b. A reaction force [symbol] (not shown in FIG. 1) is exerted from the bottom end 3b toward the top end 3a on the workpiece 4. In the case of this representation, since the machining support and the workpiece are arranged essentially horizontally, the force vector [symbol] is in the opposite orientation to the vector [symbol] . In particular, we have [symbol] =−f [symbol] for a certain number f>0.

During the machining of the workpiece 4, the machining dust 15 is produced and contained in a gas 13 consisting mainly of ambient air. These dusts 15 are likely to remain at least partially on the surface of the workpiece 4 and/or to be thrown into the vicinity of the workpiece 4.

The laser machining device 1 also comprises generating means 8 and directing means 10 to generate a laminar clean air gap 9 toward a zone 11 lying above the machining support 3.

According to the embodiment shown, the zone 11 is an open ellipsoid comprising the upper surface of the workpiece 4 in its inside. The shape and position of the zone 11 shown are not limiting. The zone 11 shown is fictitious. It is a purely illustrative delineation of a portion of the space above the machining support 3, toward which the air gap 9 is directed.

The direction of the air gap 9 by means of the direction means 10 is essentially along a main trajectory 12 characterized by the vector [symbol] between the direction means 10 and the zone 11, and thus above the machining support 3. In the case of this representation, the vector [symbol] is of the form (−x′,−y′,z′) for numbers x′,y′,z′>0. This vector is directed partially from the bottom end 3b to the top end 3a. Consequently, the scalar product of the vectors [symbol] and [symbol] is necessarily positive and, in the embodiment of the invention currently commented, the scalar product of the vectors [symbol] and [symbol] is negative:

[symbol]

| [symbol] =0x′+0y′−zz′=−zz′<0.

In the embodiment illustrated, the attack trajectory 7 is directed from the “top to the bottom” while the air gap 9 is directed obliquely “from the bottom to the top” so as to pass over the workpiece 4, in the zone 11. Preferably, the air gap passes approximately one centimeter above the top surface of the workpiece 4.

As a particular representative numerical example, if we note θ the smallest angle bringing the vector \vec{v} to the vector [symbol] , and if we take the values (for example, in meters, but the unit of measurement has no impact on the calculation) x′=2, y′=2, z′=1 and z=4, then we get

$$〈 \vec{AB} \vert \vec{v} 〉 = \{ \begin{matrix}\sqrt{{2}^{2} + {2}^{2} + {1}^{2}} \sqrt{{0}^{2} + {0}^{2} + {4}^{2}} cos θ \\ - {zz}^{′} = - 4\end{matrix} ⇔ 12 cos θ = - 4 ⇔ cos θ = - \frac{1}{3} ⇔ θ = 109 , {5}^{∘} .$$

This angle is shown in FIG. 1. It belongs to a preferred range of values. Typically, the angle θ is between 98° and 170°.

Thus directed, the air gap 9 creates a suction effect above the workpiece 4, in the zone 11, according to at least a partially vertical direction, i.e. following at least partially the vector − [symbol] , this effect of pulling away from the surface of the workpiece 4 and entraining the gas 13 comprising the machining dust 15. This gas 13 is essentially sucked in by the air gap 9, mixed and entrained by it continuing its trajectory. In this way, the dust 15 is quickly, simply and efficiently pulled away and/or removed from the workpiece 4 and the machining support 3. In addition, the suction effect cools the gas 13, thus reducing the adhesion of the dust 15 to the surface of the workpiece 4.

Most of this gas 13 is recovered by recovery means 14 comprising a communication 16 to absorb the air gap 9 and the gas 13. This further reduces the risk of contamination of the workpiece 4 by the dust 15. Finally, the dust 15 is optionally separated from the air of air gap 9 and gas 13 and then treated and/or eliminated.

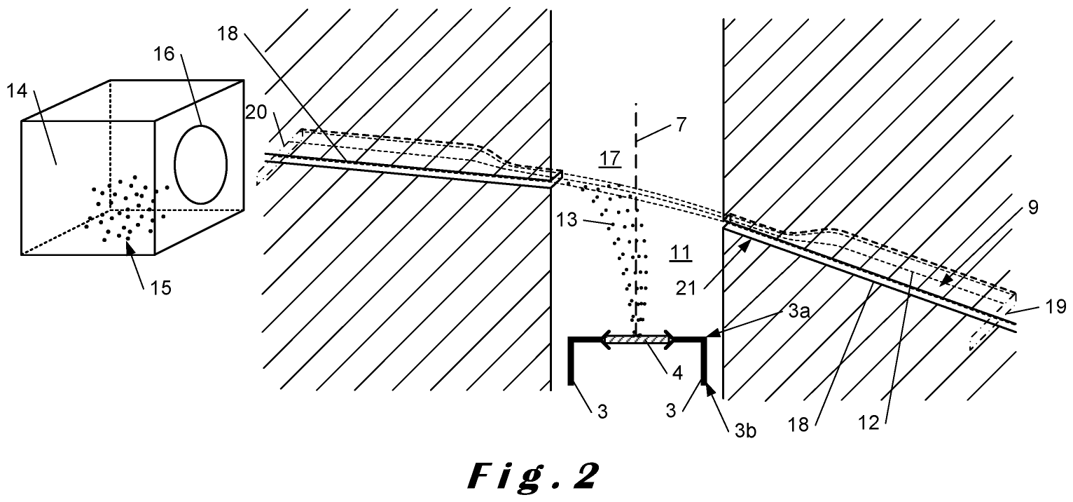

FIG. 2 illustrates a laser machining device according to a particular embodiment of the invention, this embodiment comprising, in addition to the elements of the embodiment illustrated in FIG. 1, channelling means essentially consisting of a conduct 18.

The representation of this particular embodiment is in no way limiting the shape of the conduct or the position of the conduct 18. This embodiment of the invention is not restrictive in the case where the channelling means comprise more than one conduct.

The representation and development of this particular embodiment is centered on the structural and functional consequences of the presence of a conduct as illustrated. In particular, in order not to clutter up the illustration, the laser source, the optical system, the laser beam, the generating means and the directing means of the laser machining device have no longer been represented in FIG. 2, since the representation and functionality of these elements is essentially the same as in the embodiment illustrated and commented in FIG. 1.

According to the embodiment shown, the conduct 18 has a Venturi tube structure, i.e. a depressor tube with an internal constriction. An air gap 9 is generated and directed into the flattened conduct 18 so that it is channelled to the recovery means 14. The internal narrowing of the conduct 18 is achieved by narrowing the cross-section of the conduct 18 in an intermediate portion 21 located between the ends 19, 20 of the conduct 18. In particular, the cross-sectional area of the conduct 18 at its ends 19, 20 is larger than the cross-sectional area of the conduct 18 in the intermediate portion 21. This structure of the conduct 18 can be achieved during the fabrication of the conduct 18 by shaping the material of which it is made, or, for example, by adding protrusions (not shown) in the conduct 18 at its intermediate portion 21. The air gap 9 advancing through the conduct 18 is then accelerated in the intermediate portion 21, resulting in a pressure drop therein.

An opening 17 is made in the conduct 18, close to or at least partially in the intermediate portion 21, in order to create a suction effect of the ambient air around opening 17 toward the inside of the conduct 18, thanks to the pressure drop generated at the intermediate portion 21.

This conduct is cleverly placed so that the opening 17 is located above the machining support 3 and the workpiece 4, so as to allow the laser beam to pass along its attack trajectory 7. The machining dust 15 is then sucked, within the gas 13 composed essentially of ambient air, through the opening 17 into the conduct 18, and entrained with the conduct 18 by the air gap 9 until the communication 16 of the recovery means 14 with the conduct 18. The dust 15 is thus removed and managed away from the workpiece 4.

Note that the zone 11 lying above the machining support 3 is, in the representation in FIG. 2, a portion of the space between the machining support 3 and the top part of the conduct 18, this portion including the opening 17.

The machining support 3 is preferentially coupled to a Peltier system and/or another cooling system (not shown) configured to cool the machining support 3, and thus the workpiece 4, by conduction.

In summary, the present invention relates to a laser machining device comprising, in particular, means configured to generate and direct a gas stream to zone lying above a machining support so as to create a suction effect capable of entraining machining dust away from said machining support. The method according to the invention consists essentially of a process generalizing the application of the above-mentioned laser machining device.

Once again, we wish to emphasize that the present invention has been described in relation to specific embodiments, which are purely illustrative and should not be considered as limiting. Generally speaking, it will be obvious to the person skilled in the art that the present invention is not limited to the examples illustrated and/or described above. The invention comprises each of the new characteristics as well as all their combinations.

For the purpose of this document, the terms “first”, “second”, “third” and “fourth” serve only to differentiate the different elements and do not imply any order between them. The use of the verbs “to comprise”, “to include”, “to consist”, or any other variant, as well as their conjugations, can in no way exclude the presence of elements other than those mentioned. The use of the indefinite article “an”, “a”, or the definite article “the”, to introduce an element does not exclude the presence of a plurality of these elements.

1. A method for managing machining dust during laser machining of a workpiece, said method comprising the steps of:
(i) providing a laser machining device, comprising:
a laser source;
a machining support comprising a top end and a bottom end, the machining support being configured to receive and support a workpiece by the application of a force directed from said bottom end toward said top end;
an optical system configured to direct a laser beam generated by said laser source toward said machining support according to one or more attack trajectories, each of said one or more attack trajectories being defined by a vector AB directed at least partially from said top end toward said bottom end;
a generator configured to generate a gas stream;
a director configured to direct said gas stream toward a zone positioned above said machining support; and
a collector configured to recover at least part of said gas;
(ii) placing said workpiece on said machining support;
(iii) activating said laser source to generate said laser beam;
(iv) directing said laser with said optical system toward said machining support, according to said one or more attack trajectories;
(v) activating said generator to generate said gas stream;
(vi) directing said gas stream by means of said directing means, with said director toward said zone positioned above said machining support; and
(vii) recovering at least said part of said gas with the collector,
wherein said director is configured to direct said gas stream along a main trajectory defined, above said machining support, by a vector \vec{v} directed partially from said bottom end toward said top end, to create a suction effect that entrains a gas away from said machining support; and
said gas stream is directed in step (vi) along said main trajectory, above said workpiece, to create said suction effect that entrains said gas away from said machining support.

2. The method according to claim 1, further comprising the step of cooling at least one of
said machining support,
said workpiece, and
said gas.

3. The method according to claim 1, wherein a distance, measured along a vertical direction directed from said bottom end toward said top end, separating said main trajectory and said workpiece is between 0.1 and 20 centimeters.

4. The method according to claim 3, wherein said distance is between 0.1 and 10 centimeters.

5. The method according to claim 1, wherein said gas stream generated in step (v) comprises an air gap with a width of between 10 and 30 centimeters.

6. The method according to claim 1, wherein said gas stream is generated in step (v) and directed in step (vi) with a stream velocity of between 0.2 and 10 meters per second.

7. The method according to claim 1, wherein said gas stream is generated in step (v) with a stream flow rate comprised between 6*10⁻⁴ and 30*10⁻³ cubic meters per second.

8. A laser machining device comprising:
a laser source;
a machining support comprising a top end and a bottom end the machining support being configured to receive and to support a workpiece by the application of a force directed from said bottom end toward said top end;
an optical system configured to direct a laser beam generated by said laser source toward said machining support according to one or more attack trajectories, each of said one or more attack trajectories being defined by a vector \vec{AB} directed at least partially from said top end toward said bottom end;
a generator configured to generate a gas stream;
a director configured to direct said gas stream toward a zone positioned above said machining support; and
a collector configured to recover at least part of said gas;
wherein said directing means are configured to direct said gas stream along a main trajectory defined, above said machining support, by a vector \vec{v} directed partially from said lower end toward said top end, to create a suction effect able that entrains a gas away from said machining support.

9. The device according to claim 8, wherein said one or more attack trajectories pass through said gas stream when said generator is in action.

10. The device according to claim 8 wherein said gas stream is a laminar air stream.

11. The device according to claim 8, wherein said gas stream comprises an air gap moving along a surface, a part of which is a portion of a plane parallel to said vector \vec{v}, when said generator in action; wherein said main trajectory comprises a curve on said surface; and wherein a distance between said surface and said machining support is smaller than 20 centimeters.

12. The device according to claim 8, wherein said gas comprises machining dust.

13. The device according to claim 8, further comprising a channel configured to channel said gas stream between said director and said collector.

14. The device according to claim 13, wherein said channel comprises at least one opening configured to receive said gas entrained by said suction effect, and wherein said channel is configured to channel said gas between said at least one opening and said collector.

15. The device according to claim 13, wherein said channel comprises a conduct having a cross-section of variable area, wherein
said conduct has a first and a second ends, and wherein said cross-section has, in an intermediate portion located between said first and second ends, an area smaller than the area of the cross-section at said first and second ends.

16. The device according to claim 15, wherein said suction effect is generated by a Venturi effect in said conduct.

17. The device according to claim 8, wherein said suction effect is configured to cool at least one of said machining support and said gas.

18. The device according to claim 8, further comprising a cooling system configured to cool at least one of said machining support and said gas.
